(19) United States
(12) Patent Application Publication
(10) Pub. No.: US 2018/0052574 A1
(43) Pub. Date: Feb. 22, 2018

(54) Energy Efficiency and Energy Security Optimization Dashboard for Computing Systems

(71) Applicant: USA as represented by the Secretary of the Navy, San Diego, CA (US)

(72) Inventors: Adriane Q. Wolfe, Ithaca, NY (US); Bryan L. Croft, San Diego, CA (US); Christian X. Szatkowski, La Mesa, CA (US); Douglas S. Lange, San Diego, CA (US); Jose Romero-Mariona, San Diego, CA (US)

(73) Assignee: United States of America as represented by Secretary of the Navy, San Diego, CA (US)

(21) Appl. No.: 15/243,602

(22) Filed: Aug. 22, 2016

(51) Int. Cl. G06F 3/0484; G06T 11/20; G06F 1/32

(52) U.S. Cl. CPC G06F 3/0484; G06T 2200/24; G06F 1/3209; G06T 11/206

(57) ABSTRACT

A method and system is provided for facilitating the management of computing systems through data visualizations to enhance energy efficiency and provide energy security optimization. The method and system provide for the rendering of a plurality of individual and composite widgets, which incorporate data relating to the monitored function and condition of a computing system as a whole as well as to its underlying components and supporting infrastructure. The method and system produce graphical representations that facilitate optimized manual and automated decision making concerning the operation of the computing system.

### FEDERALLY SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif. 92152; telephone (619) 553-5118; email: ssc_pac_t2@navy.mil. Reference Navy Case No. 102479.

### BACKGROUND

This invention relates generally to the provision of visualization interfaces for selectively optimizing the security, efficiency, and performance of a computing system.

Data center information management (“DCIM”) dashboards are often used to display values for security, efficiency, and performance parameters of a computing system. For example, a DCIM energy metering dashboard may generally be employed to display the single line power visualization as a graphical diagram. Such a dashboard may color code the graphical diagram to describe the health of the components and overall system, with red representing a component at or over capacity, yellow representing a component near capacity, and green representing a component that has sufficient capacity. Power systems, however, often operate at significantly reduced energy efficiency when they are under-loaded and operating below capacity. But if a computer system is under-loaded and operating inefficiently, an existing dashboard would generally only show green despite the fact that the system is under-loaded. The dashboard would disregard any inefficiency resulting therefrom. Such an output can be misleading to administrators and, in fact, actually promotes inefficiency and the drastic oversizing of equipment.

Such a scenario is not limited to energy metering dashboards. Indeed, many existing energy based dashboard systems provide simple data visualization and reporting features and offer varying charts or format representations of the data. Recognizing that there is a tradeoff between security and efficiency, which should be described in terms of finding an optimal balance between the two values, some more recent metrics have provided valued information beyond what the actual values of the data are. These more recent dashboards display metrics such as cost savings in dollar figures based upon simple calculations of energy performance (usage vs. consumption).

Therefore, a problem which still exists within existing dashboards in parameters such as security, efficiency, and performance are typically presented as components that are analyzed and visualized separately. As a result, conventional DCIM dashboards often lack the ability to leverage a combination of all three together. Because a system administrator or manager must balance these three often competing values for optimal performance, a need remains for a method to provide a dashboard which can render widgets that handle these three aspects separately and combine the parameters to describe the holistic performance of the system in a way that emphasizes optimization and cyber security. To date no known combinations and/or permutations of the stated parameters have been disclosed by other references to meet the stated objective of optimization of performance and cyber security.

### SUMMARY

The present disclosure describes an interface method and system for facilitating the management of computing systems through data visualizations to enhance energy efficiency and provide energy security optimization. The visualization interface method and system render a plurality of widgets that incorporate data relating to the monitored function and condition of a computing system as a whole and to its underlying components and supporting infrastructure. They also produce graphical representations that facilitate optimized manual and automated decision making concerned with the operation of the computing system. In an embodiment, the visualization interface method and system incorporates a power widget for visualizing efficiency, a cyber widget for visualizing security threats, a compute widget for visualizing component utilization relative to component location, and an energy widget for visualizing energy consumption. Further, embodiments of the visualization interface method and system may also incorporate composite widgets which combine the visualizations of multiple widgets, such as a cooling/compute widget, a compute/power widget, and a power/compute/cyber widget.

### BRIEF DESCRIPTION OF THE DRAWINGS

FIG. 1A shows a representative screen shot of a multi widget window visualization in accordance with the prior art.

FIG. 1B shows a representative screen shot of a multi widget window visualization in accordance with the prior art.

FIG. 1C shows a representative screen shot of a multi widget window visualization in accordance with the prior art.

FIG. 2 is a block diagram showing the relationship between individual and composite widgets of an energy efficiency and energy security optimization dashboard built in accordance with the present invention.

FIG. 3 is an exemplary energy widget rendering of an energy efficiency and energy security optimization dashboard built in accordance with the present invention.

FIG. 4 is an exemplary cyber widget rendering of an energy efficiency and energy security optimization dashboard built in accordance with the present invention.

FIG. 5 is an exemplary compute widget rendering of an energy efficiency and energy security optimization dashboard built in accordance with the present invention.

FIG. 6 is an exemplary power/compute/cyber widget rendering of an energy efficiency and energy security optimization dashboard built in accordance with the present invention on a dashboard home tab.

FIG. 7 is an exemplary power/compute/cyber widget rendering of an energy efficiency and energy security optimization dashboard built in accordance with the present invention on an energy tab.

FIG. 8 shows the steps through which a visualization interface method for an energy efficiency and energy security optimization dashboard built in accordance with the present invention generates level one, level two and level three widgets.

### DETAILED DESCRIPTION OF SOME EMBODIMENTS

As referenced herein, a widget consists of a conventional software widget, which is generally understood as a relatively small, self-contained software application or component that displays information or that provides a specific way for a user to interact with a portal, an operating system or an application.

A visualization interface method and system that provides a dashboard interface with power, cooling, computing, and cyber security data visualization and management services for computing operators and developers are described herein. The interface is defined by the capability to display both individual metrics (such as power, cooling, computing, and cyber data) as well as merged metrics; the interface displays the relationships between these different, yet related, data types through a plurality of individual and composite widgets. The widgets allow the relationships between these data types to be leveraged to enhance automatic as well as operator and designer optimization of performance. Particular emphasis is placed on visually displaying efficiency and security in a combined manner which focuses on the optimization and balance of the two parameters; this will enable operators and users to determine the balance between energy efficiency and security as well as their trade-offs.

The interface is additionally operative to present a course of action based on a given set of boundary conditions that are met. The basis for that course of action is also represented in order to give an end user clues as to why the system recommends a given course of action. Significantly, this course of action is not just limited to the standard energy based metrics of power, cooling, but includes critical factors of computing and cyber security which must be considered due to the criticality for which the system was intended—maintain cyber security and computing capability for the intended application based on given set of criteria.

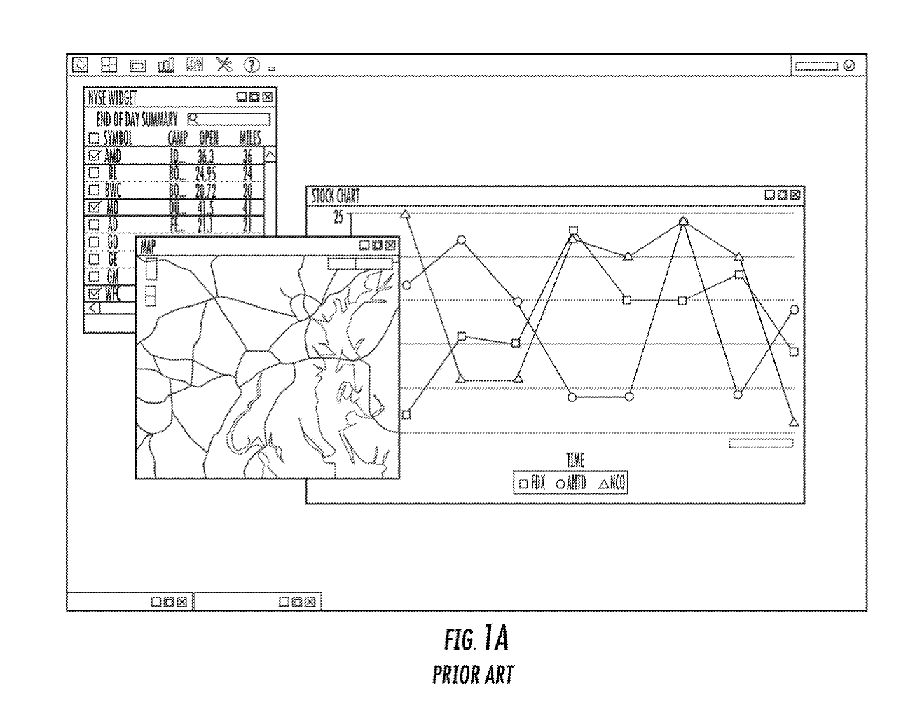

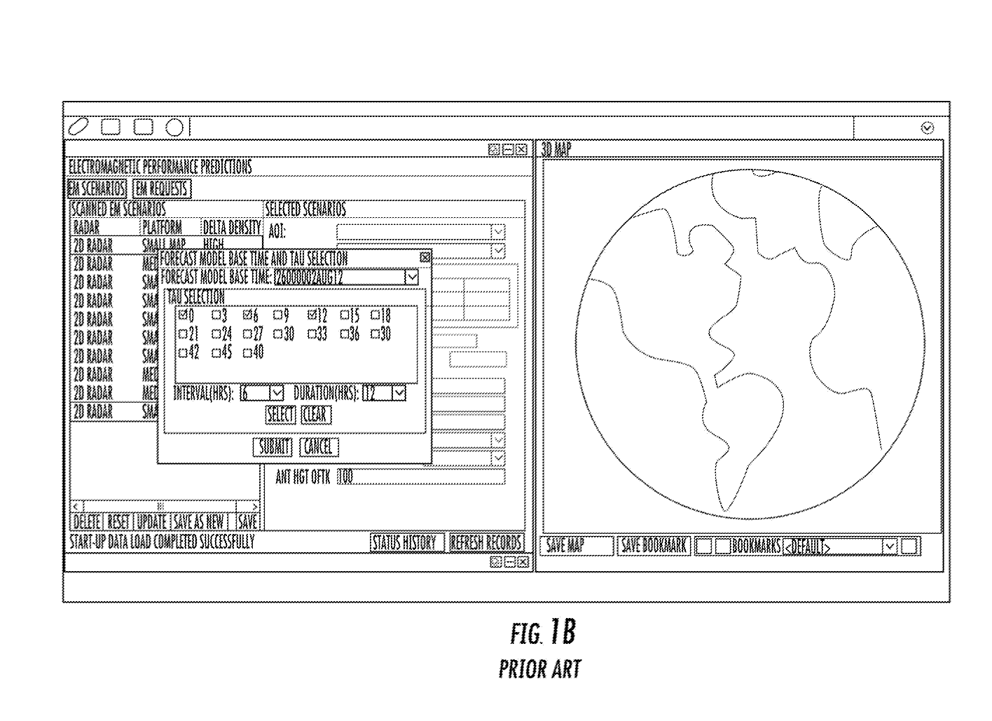

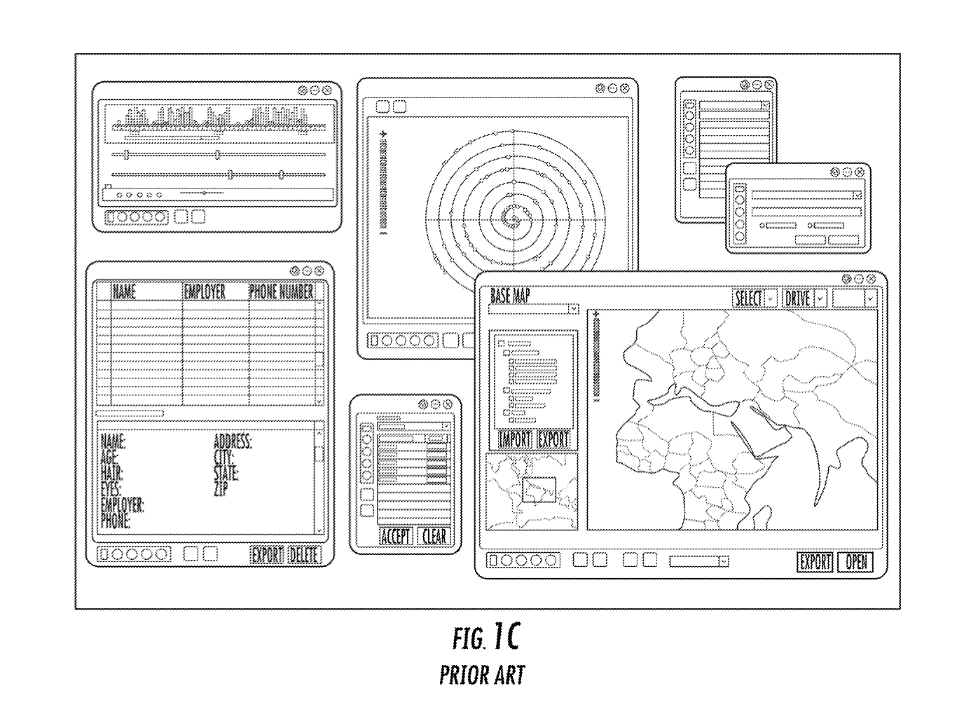

In an embodiment, the visualization interface method and system is implemented on the Ozone Widget Framework. FIGS. 1A, 1B, and 1C show an example of rendering of a plurality of individual widgets on the ozone widget framework.

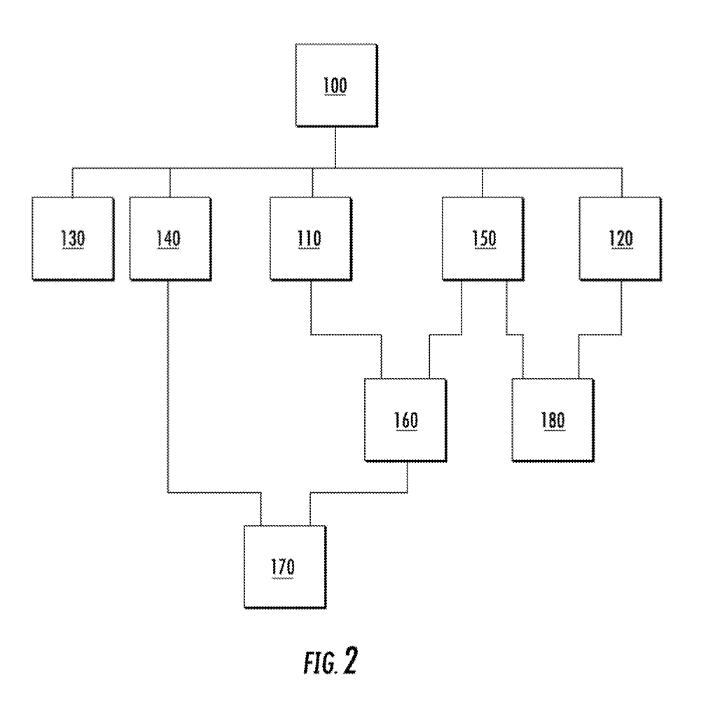

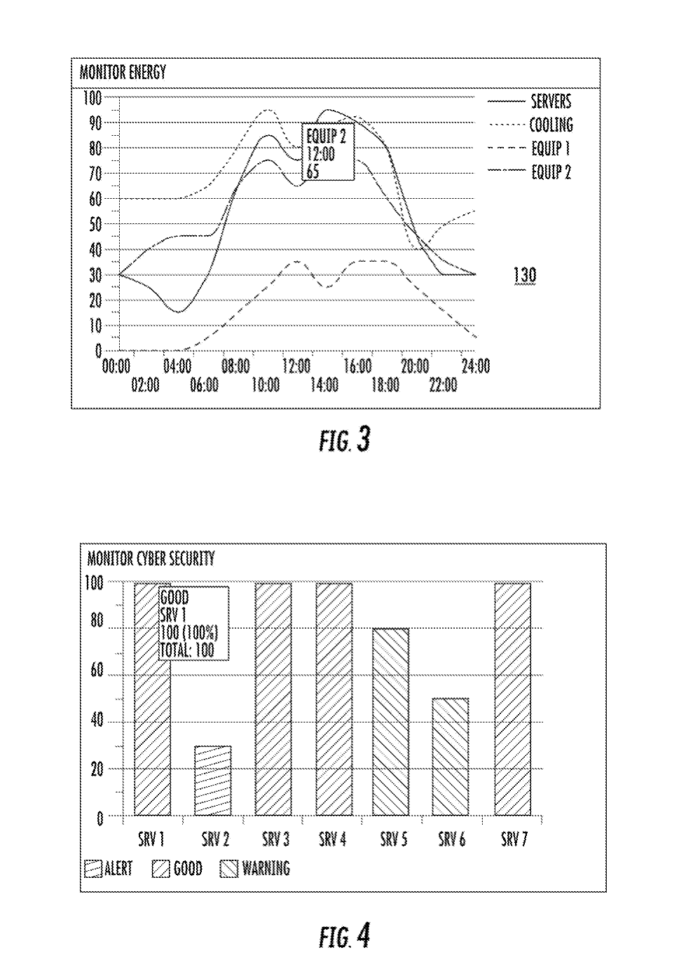

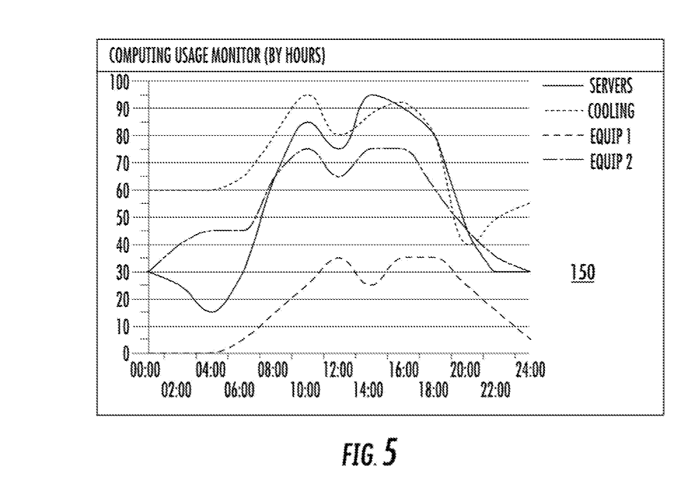

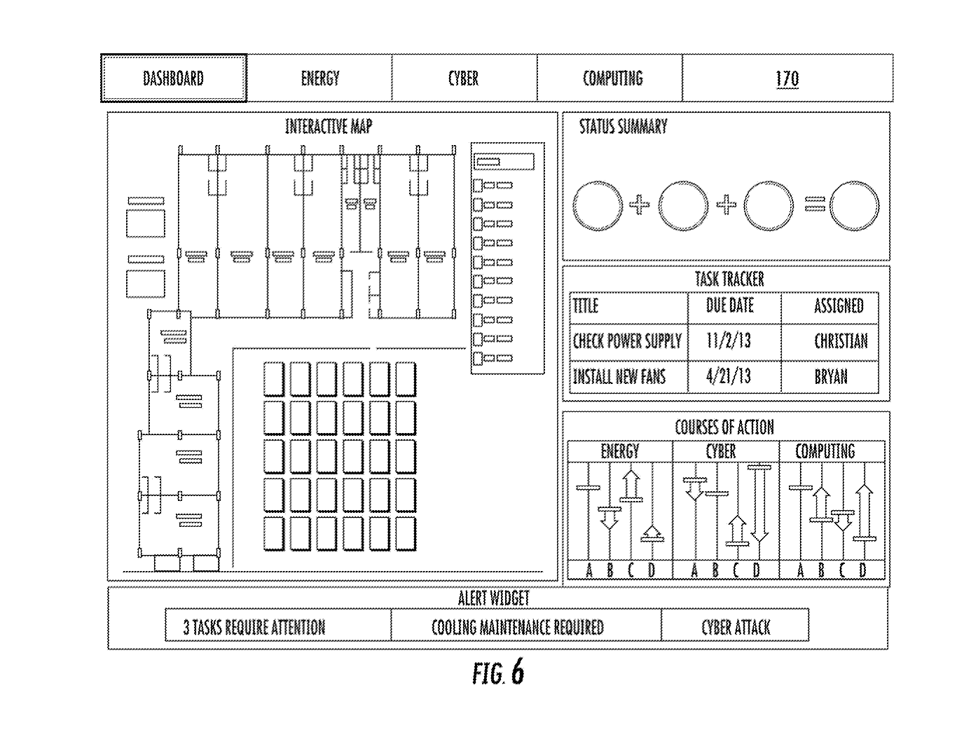

Referring now to FIGS. 2, 3, 4, 5, 6, and 7, the following individual and composite widgets are components of the dashboard of the present disclosure:

### 1) Power Widget

The power widget 110 of FIG. 2 displays a single line diagram of the power to the computing systems 100 (including supporting infrastructure). The health is displayed by violet, blue, green, yellow, and red, wherein green is the optimization or balance between efficiency (violet) and capacity (red). The course of action overlay of power widget 110 may also be applied to indicate estimate outcomes of system calculated/generated courses of action. This overlay may appear in other widgets so the same course of action can be seen as it pertains to all metrics or values that pertain to that course of action. A basis of assessment overlay for both the current power level as well as any other active course of action overlay can be visualized via several techniques, such as rollover popup or synchronized information display with rollover of the power widget 110 elements to those of other associated dashboard widgets and display elements.

### 2) Cooling Widget

The cooling widget 120 displays the geometric distribution of environmental conditions in the computing systems 100 and displays the temperature throughout the space. It is contemplated that the course of action and basis of assessment overlays and interactions also apply to this widget.

### 3) Energy Widget

The energy widget 130 displays the aggregated total energy consumption of the computing systems 100, their supporting infrastructure, the total combined energy, the power utilization effectiveness, and the total energy efficiency. The course of action and basis of assessment overlays and interactions also apply to this widget.

### 4) Cyber Widget

The cyber widget 140 displays computing systems 100 and any associated network activity from the perspective of cyber security based on energy metrics. The cyber widget 140 displays the color red for systems when they experience an instance of security risks/threats. It is contemplated that the course of action and basis of assessment overlays and interactions also apply to this widget. In some embodiments, the cyber widget 140 includes additional overlays which provide feedback on cyber security that is not based on energy metrics. Such additional overlays are used as a means to visualize and compare current standard security metrics to those introduced in this disclosure which are based on energy related values. As such, the visualization of the cyber widget 140 provides valued insight into the ability of each approach to identify security issues through a rendering which allows a comparison of when both correctly react to cyber attacks, or if one or the other reacts. As such, both approaches can be visualized and used to formulate part of the basis of assessment for cyber attacks. Accordingly, the cyber widget 140 is able to provide the operators with information that would support the detection of cyber attacks or threats that traditionally would go undiscovered if the information was not combined.

### 5) Compute Widget

The compute widget 150 displays the central processing unit (“CPU”), ram, and virtual machine (“VM”) utilization of each server in the computing systems 100 based on the geometric location of the server. The display shows green, yellow, and red to describe the capacity of the server. A general color scheme of green is good, yellow represents performance is below expectation, and red indicates a problem, alert or some indication that part not working. It is contemplated that course of action and basis of assessment overlays and interactions also apply to this widget. In some embodiments, additional overlays are provided which provide a history of computation workload based on some temporal scale as well as the desired and/or expected current or future computation workload. Such additional overlays thereby provide additional cues as to how the computational systems have performed over time as well as the expected current and future computational workload. This has a unique tie with power consumption and saving to be utilized by the system in its optimization efforts.

### 6) Compute/Power Widget

The compute/power widget 160 pulls data from the compute widget 150 and power widget 110 to compare how much power is being used by each computing resource of the computing system 100 and how it is performing from a computing perspective. This normalization of computing by power usage describes the energy efficiency of the computing. As such, the visualization provided by the compute/power widget 160 enables the manual or automatic reallocation of VMs hosted by different computing resources (such as different processers or different servers, altogether). It is contemplated that the course of action and basis of assessment overlays and interactions also apply to this widget. Advantageously, since the compute/power widget 160 is a multi-value or multi-metric widget, the visualization of the corresponding values/metrics provides additional insight to the system as a whole and the optimization and management analysis and actions that need to be performed. The visualization also provides insight into the dependence or independence of the multi-values/metrics which can be valuable for obtaining the best course of action for energy optimization, cyber security and computational workload.

### 7) Power/Compute/Cyber Widget

The power/compute/cyber widget 170 takes the data from the compute/power widget 160 and compares it to both the cyber widget 140 and also looks for unexplained anomalies in the power or compute performance as compared to historical performance in order to identify potential cyber attacks (zero day and denial of service are of particular interest). It is contemplated that the course of action and basis of assessment overlays and interactions also apply to this widget. In addition, it is appreciated that the type of multi-value/metric widget capabilities and benefits described with reference to the compute/power widget 160 may also apply for this widget.

### 8) Cooling/Compute Widget

The cooling/compute widget 180 utilizes the outputs of the cooling widget 120 and the compute widget 150. For example, the cooling/compute widget 180 documents the temperature requirements of each compute unit in order to be able to identify under or over cooled systems. In addition, the cooling/compute widget 180 also compares the temperature to the compute loading to identify physical locations where VMs should be migrated to enhance efficiency and reliability. It is contemplated that the course of action and basis of assessment overlays and interactions also apply to this widget. In addition, it is appreciated that multi-value/metric widget capabilities apply for this widget.

Referring now to FIG. 8, the process of generating an energy efficient and energy security optimization dashboard begins with the step of monitoring 210 of activity and power consumption of a computing system. In an embodiment, it is contemplated that the computing system may define a server or group of servers having operational components which include: a plurality of processors; a plurality of memory devices (including random access memory and general storage memory); an input interface, such as a keyboard, mouse, and/or touchscreen; a network interface, such as a local area network connection; a wireless local area network connection, and/or a cellular data connection; a power source, such as an connection to a local or remote electrical generator and/or a local or remote battery; and an optical output interface such as a display screen. Such a computing system will also include a plurality of environmental sensors positioned at varying locations throughout the computing system to allow for environmental conditions such as temperature, humidity, and moisture to be tracked at various locations in the computing system during the step of monitoring 210.

In some embodiments, the computing system may alternatively define a single computer or group of connected computers having such operational components.

With the computing system, related data is obtained from the step of monitoring 210. A step to generate a level one dashboard 220 is performed to run a plurality of discrete, individual widgets which utilize the data obtained to generate a plurality of discrete graphical representations of the data obtained. Specifically, a power widget utilizes power consumption data and the component activity data to display a graphical representation of efficiency. A cyber widget utilizes the power consumption data and the component activity data to display a graphical representation of security threats based a comparison of expected and actual component activity. A compute widget utilizes the component activity data to display a graphical representation of component utilization. And a cooling widget utilizes the environmental condition data to display a graphical representation of temperature distributions. In this regard, the step to generate a level one dashboard 220 renders separate widgets for each perspective which is critical for energy optimization and security.

Once the step to generate a level one dashboard 220 is complete, a step to generate a level two dashboard 230 is performed to run a plurality of composite widgets that utilize the outputs from the power widget, compute widget, and cooling widget to generate a visualization which combines the visualizations from the individual widgets with each other. Then, a step to generate a level three dashboard 240 is performed to run another composite widget which utilizes the outputs from one of the level two composite widgets, the power/compute widget, and the level one cyber widget to generate a visualization which further combines visualizations. Advantageously, the step that generates a level two dashboard 230 takes the separate widgets rendered for each perspective critical for energy optimization and security and combines information from multiple widgets to create second and third order widgets that correlate and evaluate the holistic performance of the systems.

The present method and system may provide a unique combination of energy optimization while maintaining cyber security and required computational workload as a combined solution

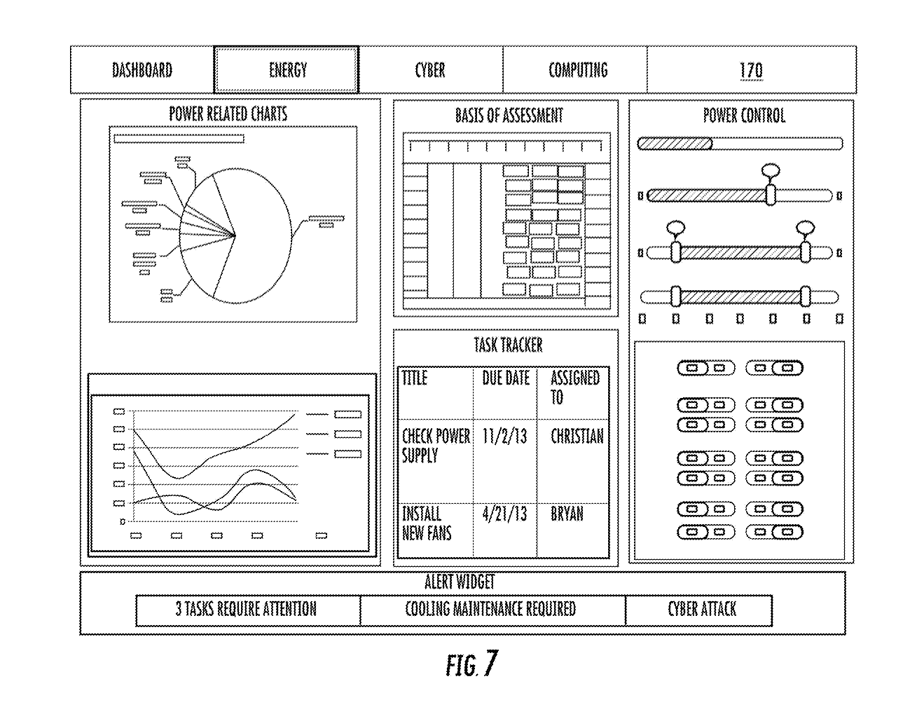

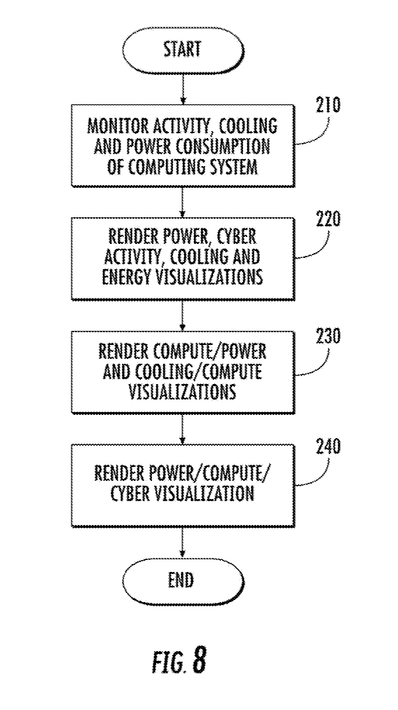

The method and system described herein may provide a suggested course of action display, as illustrated in FIGS. 6 and 7, for the end user to take in order to perform energy optimization, and maintain cyber security and computing workloads. The courses of action provide situational awareness at a higher level of abstraction, linking possible actions to the underlying data analysis and characterizing the situation. Situations are classified by the courses of action that can result in improvement by providing information at a level of abstraction that allows a user to monitor and control large configurations. For example, a power widget may display power levels and consumptions. When power levels reach a given threshold, such as exceeding a defined power consumption level, the system might provide a course of action to reduce power consumption by presenting a series of options to reduce power consumption. Each would contain implications for taking that course of action.

Based on power spikes or attempted access from a source other than a registered user, which can be an indication of potential hacker attempt, the cyber widget would quickly provide an alert to the user and present courses of action along with the implications. In this case, in which time is critical, certain courses of action can be taken automatic if the system settings or user settings have been set to be automatic. If automatic, the widget or system would indicate to the user the action that was taken and, if needed, could present options to either stop the action or allow the user to better understand the action taken.

The present method and system may provide a basis of assessment for reported or visualized outcomes of energy and cyber security data (based on energy metrics), as illustrated in FIGS. 6 and 7.

It is contemplated that the method and system described herein may be translated to other smart metering type dashboards for distribution, transmission, building, distributed compute loads, server rooms, and/or data centers.

It is contemplated that the present method and system may provide adjustable settings for automatic and manual courses based upon the level of supervision required, such as: automation with supervision by negation (automatically continues until user tells system to stop), automation with supervision by permission (stops at specified points and waits for permission to proceed), full automation (continues with no human intervention), and a manual setting (full human control and input).

The method and system described herein may provide the means to show estimated cause and effect for any actions taken by the end user. The ability to tie the individual features or metrics of an energy system, including cyber security, and to provide an analysis of recommended courses of action and projected outcomes based upon selected courses of action has not been seen in any known energy based reporting tool, dashboard or display.

The present method and system may provide a holistic suite of widgets for DCIM that can be enabled/disabled per user is new.

The method and system described herein may use computed courses of action with visualization overlays to enable estimated outcomes for energy optimization, cyber security (energy based), and computational workload.

The present method and system may use the basis of assessment indicators and display techniques to provide supporting evidence for current displayed values of energy metrics as well as course of actions is unique to this invention.

The method and system described herein may allow multi-valued/metric widgets to provide a unique method to visualize the cause and effect, inter-relationships, the dependencies or independence of energy, cyber security, and computational workload of the system.

The present method and system may use the courses of action determined through machine learning techniques to provide situational awareness at a higher level of abstraction.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A method comprising the steps of:
providing at least one power source operative to supply electricity;
providing a computing system configured to receive the electricity from the at least one power source, wherein said computing system includes a plurality of components, including at least one processor, at least one non-transitory storage medium, at least one input interface, a plurality of environmental sensors, at least one network interface, and at least one optical output interface;
monitoring power by at least one system monitor integral with the computing system, wherein the step of monitoring power includes tracking in real time the amount of electricity supplied by the at least one power source to the plurality of components of the computing system and generating a power consumption output related to the tracked amount of electricity supplied in total to the computing system and to each of the plurality of components of the computing system;
monitoring temperature by the at least one system monitor, wherein the step of monitoring temperature includes tracking in real time at least a temperature value from each of said plurality of environmental sensors and generating an environmental output related to the tracked temperature values for each of the plurality of environmental sensors;
monitoring activity by the at least one system monitor, wherein the step of monitoring activity includes tracking in real time a usage value for at least one of the at least one processor, the at least one non-transitory storage medium, the at least one network interface, and the at least one input interface and generating an activity output related to the tracked usage values for at least one of the at least one processor, the at least one non-transitory storage medium, the at least one network interface, and the at least one input interface; and
rendering, by a power widget integral with said computing system a power visualization on the at least one optical output interface which utilizes the power consumption output and the activity output to display the tracked amount of electricity supplied in the power consumption output relative to the tracked usage values in the activity output, thereby providing a graphical representation of efficiency.

2. The method of claim 1 further comprising the step of rendering, by a cooling widget integral with said computing system, a cooling visualization on the at least one optical output interface which utilizes the environmental output to display the tracked temperature values for each of the plurality of environmental sensors separately, thereby providing a graphical representation of temperature distributions.

3. The method of claim 1 further comprising the step of rendering, by an energy widget integral with said computing system, an energy visualization on the at least one optical output interface which utilizes the power consumption output to display the tracked amount of electricity supplied in total to the computer system and to each of the plurality of components of the computing system, thereby providing a graphical representation of energy consumption.

4. The method of claim 1, wherein the step of monitoring activity includes tracking in real time the usage value for the at least one processor, the at least one non-transitory storage medium, the at least one network interface, and the at least one input interface and generating an activity output related to the tracked usage values for the at least one processor, the at least one non-transitory storage medium, the at least one network interface, and the at least one input interface.

5. The method of claim 4 further comprising the step of rendering, by a cyber widget integral with said computing system, a cyber visualization on the at least one optical output interface which utilizes the power consumption output and the activity output to display the tracked amount of electricity supplied in the power consumption output relative to the tracked usage values for the at least one processor, the at least one non-transitory storage medium, the at least one network interface, and the at least one input interface in the activity output, thereby providing a graphical representation of security threats based on whether the tracked usage values of the at least one input interface justifies the tracked amount of electricity supplied and the tracked usage values of the at least one processor, the at least one non-transitory storage medium, and the at least one network interface.

6. The method of claim 1 further comprising the step of rendering, by a compute widget integral with said computing system, a compute visualization on the at least one optical output interface which utilizes the activity output to display the tracked usage values for at least one of the at least one processor, the at least one non-transitory storage medium, the at least one network interface, and the at least one input interface, thereby providing a graphical representation of component utilization relative to component location.

7. A method comprising the steps of:
providing at least one power source operative to supply electricity;
providing a computing system configured to receive the electricity from the at least one power source, wherein said computing system includes a plurality of components, including a plurality of processors, at least one non-transitory storage medium, at least one input interface, a plurality of environmental sensors, at least one network interface, and at least one optical output interface;
monitoring power by at least one system monitor integral with the computing system, wherein the step of monitoring power includes tracking in real time the amount of electricity supplied by the at least one power source to the plurality of components of the computing system and generating a power consumption output related to the tracked amount of electricity supplied in total to the computer system and to each of the plurality of components of the computing system;
monitoring temperature by the at least one system monitor, wherein the step of monitoring temperature includes tracking in real time at least a temperature value from each of said plurality of environmental sensors and generating an environmental output related to the tracked temperature values for each of the plurality of environmental sensors;
monitoring activity by the at least one system monitor, the step of monitoring activity includes tracking in real time the usage value for the plurality of processors, the at least one non-transitory storage medium, the at least one network interface, and the at least one input interface and generating an activity output related to the tracked usage values for the plurality of processors, the at least one non-transitory storage medium, the at least one network interface, and the at least one input interface, wherein said computing system has at least one virtual machine hosted thereon and the step of monitoring activity includes tracking use of the plurality of components of the computing system by the at least one virtual machine and the activity output includes data related to tracked use of the plurality of components by the at least one virtual machine; and
rendering, by a compute widget integral with said computing system, a compute visualization on the at least one optical output interface which utilizes the activity output to display the tracked usage values for at least one of the at least one processor, the at least one non-transitory storage medium, the at least one network interface, and the at least one input interface, thereby providing a graphical representation of component utilization relative to component location.

8. The method of claim 7 further comprising the step of rendering, by a power widget integral with said computing system, a power visualization on the at least one optical output interface which utilizes the power consumption output and the activity output to display the tracked amount of electricity supplied in the power consumption output relative to the tracked usage values in the activity output, thereby providing a graphical representation of efficiency.

9. The method of claim 8 further comprising the step of rendering, by a compute/power widget integral with said computing system, a compute/power visualization on the at least one optical output interface which utilizes the power visualization and the compute visualization to at least provide an interface through which the use of the plurality of components of the computing system by the at least one virtual machine can be reallocated.

10. The method of claim 9 further comprising the step of rendering, by a cyber widget integral with said computing system, a cyber visualization on the at least one optical output interface which utilizes the power consumption output and the activity output to display the tracked amount of electricity supplied in the power consumption output relative to the tracked usage values for the at least one processor, the at least one non-transitory storage medium, the at least one network interface, and the at least one input interface in the activity output, thereby providing a graphical representation of security threats based on whether the tracked usage values of the at least one input interface justifies the tracked amount of electricity supplied and the tracked usage values of the at least one processor, the at least one non-transitory storage medium, and the at least one network interface.

11. The method of claim 10 further comprising the step of rendering, by a power/compute/cyber widget integral with said computing system, a power/compute/cyber visualization on the at least one optical output interface which utilizes the compute/power visualization and the cyber visualization to at least provide a graphical representation related to anomalies in the power or compute performance.

12. The method of claim 7 further comprising the step of rendering, by a cooling widget integral with said computing system, a cooling visualization on the at least one optical output interface which utilizes the environmental output to display the tracked temperature values for each of the plurality of environmental sensors separately, thereby providing a graphical representation of temperature distributions.

13. The method of claim 12 further comprising the step of rendering, by a cooling/compute widget integral with said computing system, a cooling/compute visualization on the at least one optical output interface which utilizes the cooling visualization and the compute visualization to at least provide a graphical representation related to temperature requirements for each of the plurality of components of the computing system and present temperature of the plurality of components of the computing system and an interface through which the use of the plurality of components of the computing system by the at least one virtual machine can be reallocated.

14. The method of claim 7 further comprising the step of rendering, by an energy widget integral with said computing system, an energy visualization on the at least one optical output interface which utilizes the power consumption output to display the tracked amount of electricity supplied in total to the computer system and to each of the plurality of components of the computing system, thereby providing a graphical representation of energy consumption.

15. A method comprising the steps of:
providing at least one power source operative to supply electricity;
providing a computing system configured to receive the electricity from the at least one power source, wherein said computing system includes a plurality of components, including a plurality of processors, at least one non-transitory storage medium, at least one input interface, a plurality of environmental sensors, at least one network interface, and at least one optical output interface;
monitoring power by at least one system monitor integral with the computing system, wherein to the step of monitoring power includes tracking in real time the amount of electricity supplied by the at least one power source to the plurality of components of the computing system and generating a power consumption output related to the tracked amount of electricity supplied in total to the computer system and to each of the plurality of components of the computing system;
monitoring temperature by the at least one system monitor, wherein the step of monitoring temperature includes tracking in real time at least a temperature value from each of said plurality of environmental sensors and generating an environmental output related to the tracked temperature values for each of the plurality of environmental sensors;
monitoring activity by the at least one system monitor, the step of monitoring activity includes tracking in real time the usage value for the plurality of processors, the at least one non-transitory storage medium, the at least one network interface, and the at least one input interface and generating an activity output related to the tracked usage values for the plurality of processors, the at least one non-transitory storage medium, the at least one network interface, and the at least one input interface;
rendering, by a power widget integral with said computing system, a power visualization on the at least one optical output interface which utilizes the power consumption output and the activity output to display the tracked amount of electricity supplied in the power consumption output relative to the tracked usage values in the activity output, thereby providing a graphical representation of efficiency;
rendering, by a cyber widget integral with said computing system, a cyber visualization on the at least one optical output interface which utilizes the power consumption output and the activity output to display the tracked amount of electricity supplied in the power consumption output relative to the tracked usage values for the at least one processor, the at least one non-transitory storage medium, the at least one network interface, and the at least one input interface in the activity output, thereby providing a graphical representation of security threats based on whether the tracked usage values of the at least one input interface justifies the tracked amount of electricity supplied and the tracked usage values of the at least one processor, the at least one non-transitory storage medium, and the at least one network interface;
rendering, by a compute widget integral with said computing system, a compute visualization on the at least one optical output interface which utilizes the activity output to display the tracked usage values for at least one of the at least one processor, the at least one non-transitory storage medium, the at least one network interface, and the at least one input interface, thereby providing a graphical representation of component utilization relative to component location; and
rendering, by a cooling widget integral with said computing system, a cooling visualization on the at least one optical output interface which utilizes the environmental output to display the tracked temperature values for each of the plurality of environmental sensors separately, thereby providing a graphical representation of temperature distributions.

16. The method of claim 15, wherein said computing system has at least one virtual machine hosted thereon and the step of monitoring activity includes tracking use of the plurality of components of the computing system by the at least one virtual machine and the activity output includes data related to tracked use of the plurality of components by the at least one virtual machine.

17. The method of claim 16 further comprising the step of rendering, by a compute/power widget integral with said computing system, a compute/power visualization on the at least one optical output interface which utilizes the power visualization and the compute visualization to at least provide an interface through which the use of the plurality of components of the computing system by the at least one virtual machine can be reallocated.

18. The method of claim 17 further comprising the step of rendering, by a power/compute/cyber widget integral with said computing system, a power/compute/cyber visualization on the at least one optical output interface which utilizes the compute/power visualization and the cyber visualization to at least provide a graphical representation related to anomalies in the power or compute performance.

19. The method of claim 16 further comprising the step of rendering, by a cooling/compute widget integral with said computing system, a cooling/compute visualization on the at least one optical output interface which utilizes the cooling visualization and the compute visualization to at least provide a graphical representation related to temperature requirements for each of the plurality of components of the computing system and present temperature of the plurality of components of the computing system and an interface through which the use of the plurality of components of the computing system by the at least one virtual machine can be reallocated.

20. The method of claim 16 further comprising the step of rendering, by an energy widget integral with said computing system, an energy visualization on the at least one optical output interface which utilizes the power consumption output to display the tracked amount of electricity supplied in total to the computer system and to each of the plurality of components of the computing system, thereby providing a graphical representation of energy consumption.
